(19) United States
(12) Patent Application Publication
(10) Pub. No.: US 2022/0327436 A1
(43) Pub. Date: Oct. 13, 2022

(54) PROCESSING ATTENDEE INFORMATION FOR A VIRTUAL EVENT

(71) Applicant: INTERNATIONAL BUSINESS MACHINES CORPORATION, ARMONK, NY (US)

(72) Inventors: Scott Nidell, Georgetown, TX (US); Christopher Lazzaro, Austin, TX (US); Timothy Lee Pomeroy, Appleton, WI (US)

(21) Appl. No.: 17/301,616

(22) Filed: Apr. 9, 2021

(51) Int. Cl. G06Q 10/02; G06Q 20/02; G06Q 20/40; G06Q 20/22; H04L 12/18

(52) U.S. Cl. CPC G06Q 10/02; G06Q 20/02; G06Q 20/40; G06Q 20/29; H04L 12/1818; G06Q 40/02

(57) ABSTRACT

A computer-implemented method and a computer system process attendee information for a virtual event. The method includes receiving a registration for a virtual event from a computing device of an event organizer. The method also includes transmitting an entitlement token to each of a plurality of participant computing devices. In addition, the method includes receiving attendee information from two or more of the plurality of participant computing devices. The attendee information for each of the two or more participant computing devices includes the entitlement token and information for a proposed transaction. The method further includes determining if the proposed transaction is authorized by the event organizer. The method also includes generating aggregate transaction data, which includes a sum of the proposed transactions determined to be authorized by the event organizer. Lastly, the method includes transmitting the aggregate transaction data to the computing device of the event organizer.

### FIELD

Embodiments relate generally to virtual events, and more particularly to a virtual event or meeting where multiple attendees are located at geographically disbursed venues and each attendee engages in a transaction with a local venue host.

### BACKGROUND

It is common to have events or meetings where multiple people attend a single location. Nowadays, videotelephony services on the Internet make it possible to conduct these events across many different geographies and time zones as a “virtual meeting.” Videotelephony enables the reception and transmission of audio-video signals by users in different locations, thereby providing a means to communicate video and voice between people in real time. Each meeting participant may communicate a video image of themselves along with audio of their voice using a personal computing device, such as a smart phone, tablet computing device, or personal computer.

Each person attending a virtual meeting may participate from any location he or she chooses. A person may attend from an office location or from home. In some situations, an attendee may participate in a virtual meeting at a local public venue, such as a restaurant.

### SUMMARY

An embodiment is directed to a computer-implemented method for processing attendee information for a virtual event. The method may include receiving a registration for a virtual event from a computing device of an event organizer. The method may also include transmitting an entitlement token to each of a plurality of participant computing devices. In addition, the method may include receiving attendee information from two or more of the plurality of participant computing devices. The attendee information for each of the two or more participant computing devices may include the entitlement token and information for a proposed transaction. The method may further include using the received attendee information and the information for the proposed transaction for each of the two or more of the plurality of participant computing devices to determine if the proposed transaction is authorized by the event organizer. The method may also include generating aggregate transaction data. The aggregate transaction data may include a sum of the proposed transactions determined to be authorized by the event organizer. Lastly, the method may include transmitting the aggregate transaction data to the computing device of the event organizer.

In an embodiment, the method may include enrolling the plurality of participant computing devices at the server based on participants listed in the registration for the virtual event.

In an embodiment, the entitlement token may be a virtual account mapped to an authorized account included in the registration for the virtual event or, in another embodiment, an event code to be transmitted to the computing devices of the participants listed in the registration for the virtual event.

In an embodiment, determining if a proposed transaction is authorized by the event organizer may include comparing the received attendee information for the proposed transaction to the registration for the virtual event and authorizing settlement of the proposed transactions determined to be authorized by the event organizer.

In an embodiment, transmitting the aggregate transaction data to the computing device of the event organizer may include transmitting the aggregate transaction data to a third party, wherein the third party determines if an aggregate transaction is authorized by the third party.

In another embodiment, transmitting the aggregate transaction data to the computing device of the event organizer may include generating a record of the proposed transactions determined to be authorized by the event organizer that includes the attendee information of the proposed transactions determined to be authorized by the event organizer. In a further embodiment, transmitting the aggregate transaction data to the computing device of the event organizer further may include requesting settlement of the aggregate transaction.

In addition to a computer-implemented method, additional embodiments are directed to a system and a computer program product for processing attendee information for a virtual event.

Another embodiment is directed to a computer-implemented method for processing attendee information for a virtual event that may include receiving attendee information at a server from two or more of a plurality of participant computing devices. The attendee information for each of the two or more participant computing devices may include an entitlement token and information for a proposed transaction. The method may also include using the received attendee information and the information for the proposed transaction for each of the two or more of the plurality of participant computing devices to determine if the proposed transaction is authorized by the event organizer. The method may further include generating aggregate transaction data. The aggregate transaction may include a sum of the proposed transactions determined to be authorized by the event organizer. The method may further include transmitting the aggregate transaction data to the computing device of a third party. Lastly, the method may include determining by the third party if the aggregate transaction is authorized.

In an embodiment, the method may include transmitting a single authorization determination for the aggregate transaction to the server.

In a further embodiment, the determining by the third party if the aggregate transaction is authorized may include performing a database query for the aggregate transaction.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of an example computer system in which various embodiments may be implemented.

FIG. 2 shows an example of processing attendee information for a virtual event between an event organizer, a proxy agent and enrolled participants according to an embodiment.

FIG. 3 is a flow chart diagram for processing attendee information of a virtual event in accordance with one or more embodiments.

FIG. 4A shows an example card settlement system according to various embodiments.

FIG. 4B shows another example card settlement system according to various embodiments.

FIG. 5 depicts a cloud computing environment according to an embodiment.

FIG. 6 depicts abstraction model layers according to an embodiment.

### DETAILED DESCRIPTION

A common way to improve retention of employees at companies and also increase productivity is to regularly engage teams in company events and outings. A traditional team engagement activity might include a gathering at a restaurant, sports venue, or some other game or leisure center that would typically be covered by the employer through its managers. The manager would typically pay for food, activities and other items that encourage engagement and foster teamwork outside the workplace. In many cases, the team is centered around a single office and the group can easily have a single outing with the entire team in attendance. Rather than each person separately paying for their meal, the manager would work with the venue and a single charge for all of the meals to a corporate credit card assigned to the manager would be made. There would be a single charge, a single receipt and one reconciliation on the corporate card statement that would keep management of such activities simple.

It is increasingly more complicated in today's workplace where multiple people are spread out in many different locations that are geographically separated by hundreds or even thousands of miles, in different states within the USA or spread across the globe in disparate countries and time zones. In such a scenario, where twenty (20) people may be spread out in various locations, hosting a team event such as described above is problematic. If everyone is in a single time zone or neighboring time zone, then the manager could take up to 20 separate orders that may have distinct instructions on how to be fulfilled and place a consolidated order themselves to simplify payment. In another example, each team member could use the single corporate credit card at their location, but the 20 almost simultaneous transactions could raise problems with the credit card company, believing that there is fraud taking place due to the transactions for the single card originating at the multiple, geographically dispersed locations in a short time period. Another problem is the presence of 20 transactions and the burden of reconciling all those transactions for the manager, potentially resulting in hours of paperwork between management, finance, and the team members explaining what the charges are for and why it happened. This could mean possibly hundreds of hours wasted between the departments. What is needed is a way to consolidate the charges such that the manager is presented with a single total bill that can be easily reconciled and tracked to a specific event.

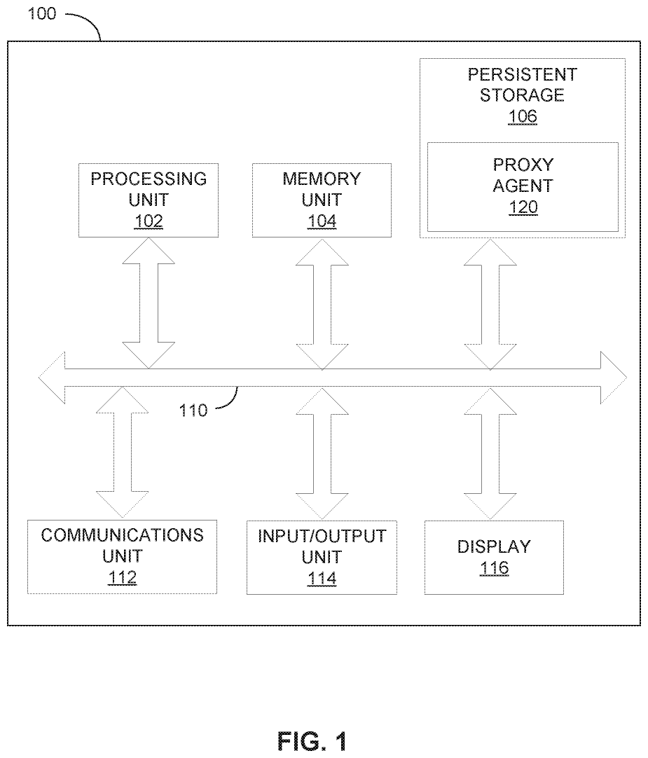

Referring now to FIG. 1, there is shown a block diagram illustrating a computer system 100 in an embodiment. It should be noted that the proxy agent 120 may be embedded in a server or other computer system that is accessible through a network. The proxy agent 120 may be accessible to users via any client device such as a desktop computer or mobile device such as a smartphone or tablet. As shown, a computer system 100 includes a processor unit 102, a memory unit 104, a persistent storage 106, a communications unit 112, an input/output unit 114, a display 116, and a system bus 110. Computer programs such as the proxy agent 120 may be stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor 102 gives to memory 104 along with a request to read and/or write. Usually, the reading and interpretation of an encoded instruction at an address causes the processor 102 to fetch a subsequent instruction, either at a subsequent address or some other address. The processor unit 102, memory unit 104, persistent storage 106, communications unit 112, input/output unit 114, and display 116 interface with each other through the system bus 110.

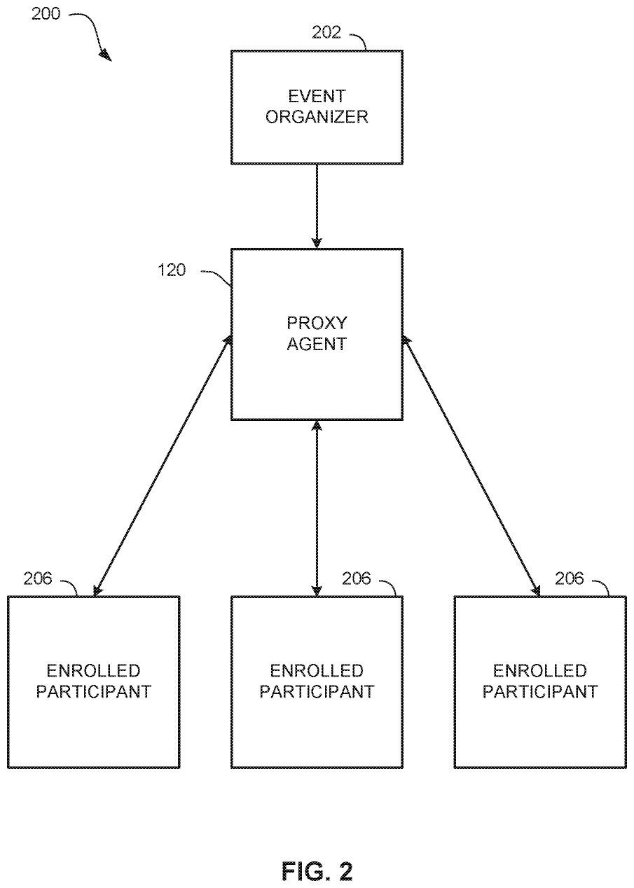

Referring to FIG. 2, an example 200 of processing attendee information for a virtual event is shown according to embodiments. In the example, an event organizer 202 may register a virtual event, which may include providing information to the proxy agent 120 related to the virtual event. The proxy agent 120 may use this information to create the virtual event within its memory. It should be noted that while the block diagram indicates an event organizer 202 and enrolled participants 206, these blocks may also represent a computing device. An event organizer 202 may transmit the event registration using a computing device such as a desktop in an office or home, or laptop, tablet, smartphone or any other device suitable for access to a computer network. The information within the event registration may include a time period for the event, a list of participants that may participate in the event and limits on the resources that may be used such as a list of authorized vendors or a credit limit. The event organizer 202 may also provide an authorized payment method to utilize for settlement (or payment) of any charges incurred during the event. Once the proxy agent 120 has the information it needs to create the event, it may enroll participants in the virtual event and generate entitlement tokens for the virtual event that it may transmit directly to the computing device(s) of either the event organizer 202 or one or more enrolled participants 206 or both. In an embodiment, these entitlement tokens may be in the form of virtual credit cards as described below, that are tied to the payment method provided in the event registration. In another embodiment, the entitlement token may be an event code, which may be a randomly generated text string using letters, numbers or symbols that is intended to be secure enough so that only the event organizer 202 and enrolled participants 206 are aware of the code and may use it. In this embodiment, the event code is mapped to the payment method provided in the event registration.

The enrolled participants 206 may then use the entitlement token, whether an event code or a virtual credit card, to create transactions related to the event, using a computing device such as a desktop in an office or home, or laptop, tablet, smartphone or any other device suitable for access to a computer network. The computing device of the enrolled participant may receive the entitlement token to settle charges remotely and directly with the chosen vendor. The proxy agent 120 may monitor and analyze these proposed transactions as they come in to ensure that they are authorized, e.g., within the specified time period for the event and that only enrolled participants 206 are using the entitlement token. Once the time period is complete, or at another suitable time interval, the proxy agent 120 may aggregate authorized transactions, i.e., the transactions it has received and determined as within the time period for the event and meeting all other requirements of the event registration. The balances of the individual transactions may be summed by the proxy agent 120 to form the balance of the aggregate transaction. The data for the aggregate transaction may be transmitted to the computing device of the event organizer 202.

At the same time, a request may be made to settle the charges for the virtual event with the appropriate authorized payment method. In an embodiment, this may be the payment method connected to the event organizer 202 that was entered during event registration but it should be noted that in another embodiment, the proxy agent 120 may extend credit to the event organizer 202 and manage settlement with vendors directly in addition to settling with the event organizer 202, replacing the payment method in the event registration with a payment method of the proxy agent 120. In this embodiment, a payment account (and payment method) with the proxy agent 120 as owner may be created to replace the payment method provided in the event registration, in which case the entitlement token, whether an event code or virtual credit card as described above, would be mapped to the replacement payment account instead of the payment method provided in the event registration.

As mentioned, the computing device of an event organizer 202 or an enrolled participant 206 may receive an entitlement token related to a virtual event. In some embodiments, the entitlement token is a “virtual credit card.” A virtual credit card may be a number that is associated with a credit card account but is different from the card number of the credit card account. The virtual credit card number may be randomly generated or generated in some other secure fashion. A virtual credit card may be issued on a temporary basis, such as for use in a single transaction or may be issued on the same time basis as traditional credit card. A virtual credit card may be presented to a merchant electronically, such as via near-field communication between a smart phone and a merchant terminal. The virtual credit card may be a substitute for or otherwise associated with a physical credit card and therefore the virtual credit card may also be known as a “secondary account”.

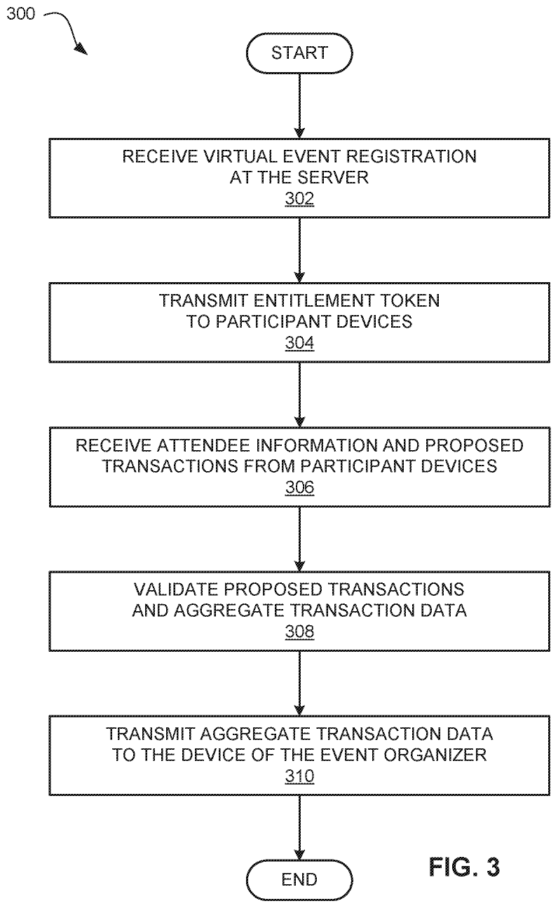

Referring to FIG. 3, an operational flowchart illustrating a process 300 is depicted according to at least one embodiment. At 302, registration information may be received about a virtual event at a server from a computing device of an event organizer 202, including the time period and the list of selected users. For example, the virtual event may be registered by a manager who is organizing a team event in a business context. Another example of someone registering a virtual event may be a parent organizing a birthday party or other outing for their child. A virtual event may have many attributes associated with it but the proxy agent 120 may require a time period for the event, such as a date or time window within which the enrolled participants 206 may incur charges, and also a list of selected participants that are authorized to incur charges. The event organizer 202 may also specify in the virtual event registration limits on resources for an event, such as specific vendors or vendor types, as well as a maximum amount that may be charged using the entitlement token that the proxy agent 120 may transmit to the computing device of an enrolled participant 206. The proxy agent 120 may also require that the event organizer 202 specify a payment method that will be associated with the virtual event and used for settlement of charges related to the virtual event.

At 304, an entitlement token may be transmitted to the computing devices of the enrolled participants 206. The list of selected participants that is entered by the event organizer 202 in the registration may be used to determine who should be enrolled in the event as a participant and therefore receive an entitlement token. In an embodiment, the entitlement token may be transmitted to the computing device of the event organizer 202 but in other embodiments, this entitlement token may be transmitted directly to the computing devices of the enrolled participants 206. For example, the entitlement token may be a virtual credit card as described above that is mapped to the payment method that was specified in the event registration by the event organizer 202. In this embodiment, the virtual credit cards are used to settle charges with vendors and the use of the virtual credit cards may be managed centrally. In another embodiment, an event code may be generated for the event that may be provided to the computing devices of the enrolled participants 206. In this embodiment, the event code may be used to settle charges between the enrolled participants and vendors. In a further embodiment, a payment account (and payment method) with the proxy agent 120 as owner may be created to replace the payment method provided in the event registration, in which case the entitlement token, whether an event code or virtual credit card, would be mapped to the replacement payment account instead of the payment method provided in the event registration. The virtual event charges may be settled by the new account and the proxy agent 120 may request settlement from the event organizer 202 separately.

At 306, attendee information may be received from participant computing devices at the server. The attendee information may include the entitlement token and information for a proposed transaction, such as proposed transaction amounts for inclusion in the virtual event charges. These proposed transactions may be any transactions that are made using the entitlement token that was transmitted in 304. The attendee information that is received may include the computing device that is transmitting the information, the date and time of a proposed transaction, the entitlement token used or any other information that may be used to uniquely identify the participant or the transaction for the purpose of determining if the transaction is authorized for the virtual event. Attendee information may include the name and type of venue or vendor. Attendee information may include a description of the product or service to be provided by the venue or vendor in a proposed transaction.

At 308, it may be determined whether the proposed transaction is valid or authorized, e.g., having taken place during the time period specified in the event registration and the person using the entitlement token is on the list of enrolled participants. It may also be ensured that any other requirements in the event registration, e.g., specific vendors or vendor types or maximum amount, are satisfied before authorizing the transaction. All proposed transactions that meet the event requirements may be validated or authorized for inclusion in the charges for the virtual event. Also at 308, the data, i.e., the attendee information as well as a balance that may be calculated for each valid or authorized transaction, for all proposed transactions determined to be authorized may be consolidated into an aggregate transaction that includes a sum of the balances of the validated or authorized transactions that serves as the balance for the aggregate transaction. It should be noted that a proposed transaction using the entitlement token may be a charge incurred by an enrolled participant 206 with a virtual credit card or other form of payment to the vendor or may also be the use of an event code as described above, which in an embodiment may mean the proposed transaction is simply a confirmation that the enrolled participant 206 has used the entitlement token at the vendor. In this embodiment, the balance of the proposed transaction may represent a maximum pre-paid amount that would be used in the sum of balances for the aggregate transaction (as opposed to an actual amount charged). This aggregate transaction represents the charges incurred by all participants at the event and will be used to settle, i.e., pay, the virtual event charges with the event organizer 202.

At 310, the data for the aggregate transaction may be transmitted to the computing device of the event organizer 202. This data may be an itemized record of all the authorized transactions that are included in an aggregate transaction in a form that may be used to report the virtual event and its constituent transactions to an appropriate accounting authority. At the same time as the record is generated, in an embodiment, the payment method provided in the event registration, e.g., a corporate credit card of the event organizer, may be used to settle the charges associated with the virtual event, e.g., the balance of the aggregate transaction. A third party, e.g., a bank, mat issue the corporate card to the event organizer. In another embodiment, a payment account connected to the proxy agent 120 may have been created that will be used to satisfy the charges made by the enrolled participants 206, in which case the event organizer 202 may arrange to pay the aggregate virtual event charges directly to the proxy agent 120. It should be noted that exact amounts need not match exactly throughout the system as there may be fees charged or payment terms offered and accepted by an event organizer 202. It is only necessary that an aggregate transaction be connected to a virtual event so that it can be recorded and tracked.

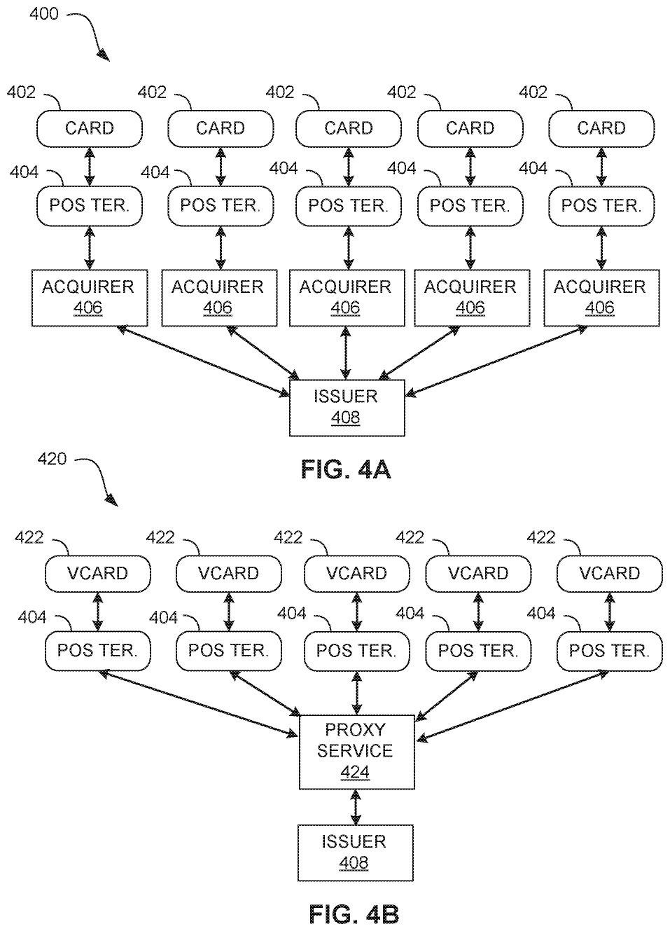

FIGS. 4A and 4B illustrate a technological improvement according to various embodiments. FIG. 4A shows a card payment system. When a cardholder presents a card 402 to a merchant, the merchant puts the card in a POS (point of sale) terminal along with an amount. FIG. 4A shows five instances of transaction data for a card 402 being captured by five different POS terminals 404. The cards 402 may be a physical debit or credit card, or a virtual debit or credit card. The POS terminals 404 may be disposed in different geographic locations. The account number (or virtual account number) and amount are sent from each POS terminal over a network, passing through intermediaries, such as acquirer 406 to a card issuer, e.g., a bank, that issued the credit card. The acquirer 406 may be a bank or other party that processes card transactions for the merchant. When the computer of the card issuer, e.g., the issuing bank's computer, receives the card number and amount, it performs a process for authorizing or declining the transaction. For example, the issuing bank's computer may perform a database query to determine if the amount of the proposed charge would exceed a credit limit or account balance. The issuing bank's computer may also perform a database query to determine if the card has been reported lost or stolen. Once the database queries are complete, issuing bank then sends the authorization or declination decision over the network back to the merchant. In the example of FIG. 4A, all of the cards 402 are issued by the same bank. Of course, each of the cards could be issued by different banks, but it will be appreciated that the depicted scenario with a single issuer corresponds with multiple employees each using their own corporate credit card, or the multiple employees each being using the same corporate credit card. Thus, the depicted scenario corresponds with all corporate credit cards having the same card issuer, as may be the case with an example of a virtual meeting described herein.

It may be seen from FIG. 4A that the issuing bank's computer performs the authorization or declination decision five times. A virtual meeting may have 2 or 3 participants or as many as 20-30, or even 100. The issuing bank's computer will need to perform the authorization or declination decision, including any database queries, for each participant. Where 20 participants are submitting charges to 20 merchants, the computer at the issuing bank needs to perform 20 authorization/declination determinations and send 20 decisions back.

Embodiments of the present invention provide a technological improvement for the issuing bank's computer and the card payment system network. According to the invention, the computer of the card issuer 408 only needs to perform one authorization/declination determination and send one decision back to the merchant.

FIG. 4B shows a card payment system according to various embodiments. The POS terminals 404 interface with the proxy service 424. The proxy service 424 aggregates the charges received from each of the POS terminals 404. The proxy service 424 may perform a process to determine if the charge is for an appropriate category, in a specified time period, and within an amount specified by the organizer of the virtual event, e.g., operation 308. The proxy service 424 does not perform the authorization or declination decision that the computer of the card issuer 408 would perform, such as whether the proposed transaction would exceed a credit limit or account balance. The proxy service 424 sends a single aggregate charge to the issuing bank 408. In contrast to FIG. 4A, the computer of the card issuer 408 receives a single transaction request instead of 20, 30, or 100 requests. The card issuer 408 makes a single authorization or declination decision and sends a single message communicating the decision back to proxy service 424. Various embodiments represent a technological improvement for the issuing bank by reducing processing by the issuing bank's computers, e.g., a reduced number of database queries and a reduced number of network communications.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

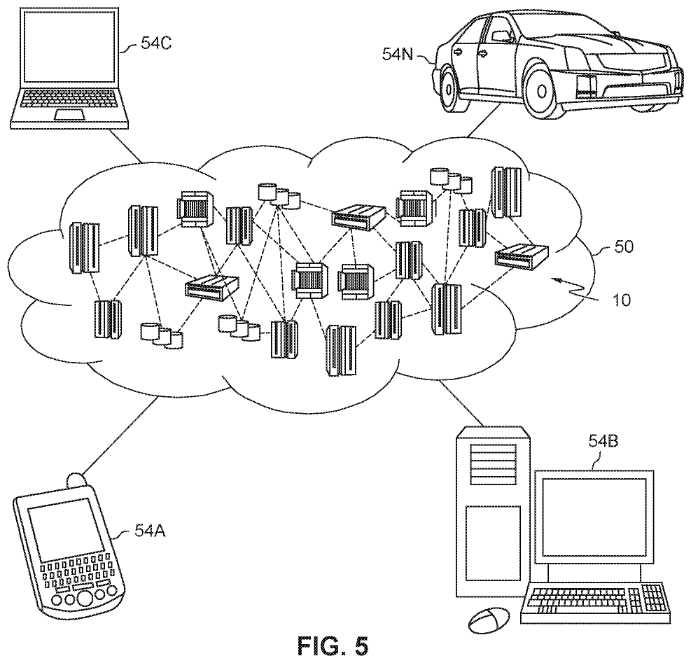

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

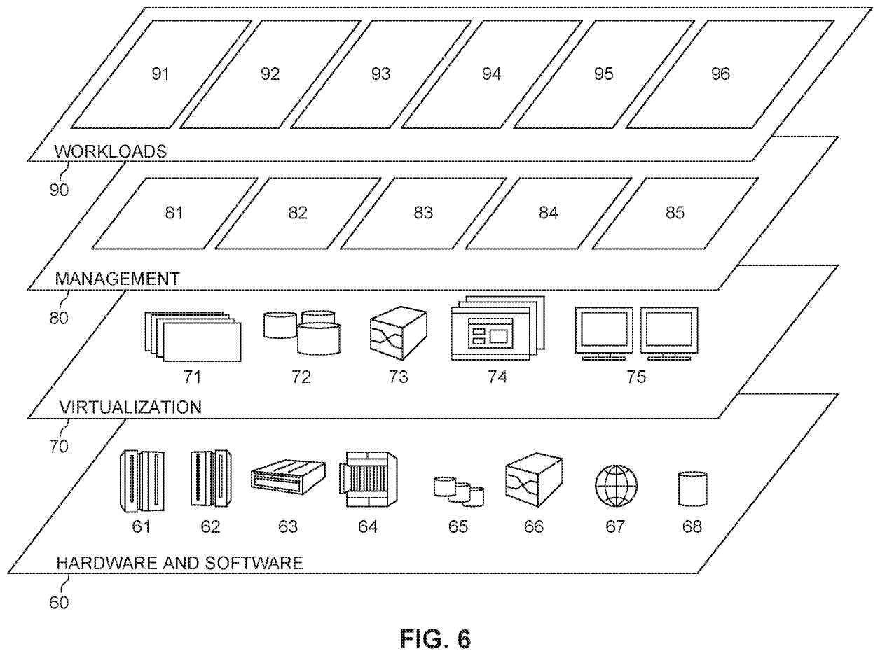

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and other applications 96 such as the proxy agent 120.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for processing attendee information for a virtual event, comprising:
receiving a registration for a virtual event at a server from a computing device of an event organizer;
transmitting an entitlement token to each of a plurality of participant computing devices by the server;
receiving attendee information from two or more of the plurality of participant computing devices, wherein the attendee information for each of the two or more participant computing devices includes the entitlement token and information for a proposed transaction;
for each of the two or more of the plurality of participant computing devices, using the received attendee information and the information for the proposed transaction to determine, by the server, if the proposed transaction is authorized by the event organizer;
generating aggregate transaction data by the server, the aggregate transaction including a sum of the proposed transactions determined to be authorized by the event organizer; and
transmitting, by the server, the aggregate transaction data to the computing device of the event organizer.

2. The computer-implemented method of claim 1, further comprising enrolling the plurality of participant computing devices at the server based on participants listed in the registration for the virtual event.

3. The computer-implemented method of claim 1, wherein the entitlement token is a virtual account mapped to an authorized account included in the registration for the virtual event.

4. The computer-implemented method of claim 1, wherein the entitlement token is an event code to be transmitted to the computing devices of the participants listed in the registration for the virtual event.

5. The computer-implemented method of claim 1, wherein determining, by the server, if a proposed transaction is authorized by the event organizer comprises:
comparing the received attendee information for the proposed transaction to the registration for the virtual event; and
authorizing settlement of the proposed transactions determined to be authorized by the event organizer.

6. The computer-implemented method of claim 1, wherein transmitting, by the server, the aggregate transaction data to the computing device of the event organizer further comprises transmitting the aggregate transaction data to a third party, wherein the third party determines if an aggregate transaction is authorized by the third party.

7. The computer-implemented method of claim 1, wherein transmitting, by the server, the aggregate transaction data to the computing device of the event organizer further comprises generating a record of the proposed transactions determined to be authorized by the event organizer that includes the attendee information of the proposed transactions determined to be authorized by the event organizer.

8. The computer-implemented method of claim 1, wherein transmitting, by the server, the aggregate transaction data to the computing device of the event organizer further comprises requesting settlement of the aggregate transaction.

9. A computer system comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
receiving a registration for a virtual event at a server from a computing device of an event organizer;
transmitting an entitlement token to each of a plurality of participant computing devices by the server;
receiving attendee information from two or more of the plurality of participant computing devices, wherein the attendee information for each of the two or more participant computing devices includes the entitlement token and information for a proposed transaction;
for each of the two or more of the plurality of participant computing devices, using the received attendee information and the information for the proposed transaction to determine, by the server, if the proposed transaction is authorized by the event organizer;
generating aggregate transaction data by the server, the aggregate transaction including a sum of the proposed transactions determined to be authorized by the event organizer; and
transmitting, by the server, the aggregate transaction data to the computing device of the event organizer.

10. The computer system of claim 9, further comprising enrolling the plurality of participant computing devices at the server based on participants listed in the registration for the virtual event.

11. The computer system of claim 9, wherein the entitlement token is a virtual account mapped to an authorized account included in the registration for the virtual event.

12. The computer system of claim 9, wherein the entitlement token is an event code to be transmitted to the computing devices of the participants listed in the registration for the virtual event.

13. The computer system of claim 9, wherein determining, by the server, if a proposed transaction is authorized by the event organizer comprises:
comparing the received attendee information for the proposed transaction to the registration for the virtual event; and
authorizing settlement of the proposed transactions determined to be authorized by the event organizer.

14. The computer system of claim 9, wherein transmitting, by the server, the aggregate transaction data to the computing device of the event organizer further comprises transmitting the aggregate transaction data to a third party, wherein the third party determines if an aggregate transaction is authorized by the third party.

15. The computer system of claim 9, wherein transmitting, by the server, the aggregate transaction data to the computing device of the event organizer further comprises generating a record of the proposed transactions determined to be authorized by the event organizer that includes the attendee information of the proposed transactions determined to be authorized by the event organizer.

16. The computer system of claim 9, wherein transmitting, by the server, the aggregate transaction data to the computing device of the event organizer further comprises requesting settlement of the aggregate transaction.

17. A computer-implemented method for processing attendee information for a virtual event, comprising:
receiving attendee information at a server from two or more of a plurality of participant computing devices, wherein the attendee information for each of the two or more participant computing devices includes an entitlement token and information for a proposed transaction;
for each of the two or more of the plurality of participant computing devices, using the received attendee information and the information for the proposed transaction to determine, by the server, if the proposed transaction is authorized by the event organizer;
generating aggregate transaction data by the server, the aggregate transaction including a sum of the proposed transactions determined to be authorized by the event organizer; and
transmitting, by the server, the aggregate transaction data to the computing device of a third party; and
determining by the third party if the aggregate transaction is authorized.

18. The computer-implemented method of claim 17, further comprising transmitting a single authorization determination for the aggregate transaction to the server.

19. The computer-implemented method of claim 17, wherein the determining by the third party if the aggregate transaction is authorized further comprises performing a database query for the aggregate transaction.
